(19) United States
(12) Patent Application Publication
(10) Pub. No.: US 2008/0034349 A1
(43) Pub. Date: Feb. 7, 2008

(54) INCREMENTAL PROGRAM MODIFICATION BASED ON USAGE DATA

(75) Inventors: Surupa Biswas, Redmond, WA (US); Ori Gershony, Redmond, WA (US); Jan Kotas, Redmond, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/462,672

(22) Filed: Aug. 4, 2006

(51) Int. Cl. G06F 9/44

(52) U.S. Cl. 717/121

(57) ABSTRACT

In one embodiment, a computer system performs a method for reconfiguring the data object layout within a software application binary. The method involves the computer system instantiating a software application binary. The computer system monitors the software application to identify a degree of use of each data object during instantiation of the software application. The computer system stores information that includes the degree of use of data objects monitored. The computer system terminates the software application. The computer system reconfigures the data object layout based on the stored information such that the data objects which satisfied a threshold degree of use are placed in a high-use portion of the application binary, and those data objects which failed to satisfy the threshold degree of use are placed in a low-use portion of the application binary such that order of data objects differs from the first instance of the software application.

### BACKGROUND

Computers are used all over the world to accomplish a variety of tasks. Computers accomplish tasks by processing sets of instructions derived from software source code. Software source code is typically written by a software developer using one or more programming languages. Most programming languages have a software source code compiler that allows the code to be compiled into one or more data files. Such data files may be used in conjunction with other data files to form a software application. As such, software applications can be viewed as conglomerates of data files, where each data file may be initiated by the user or by the software application to perform, or assist in performing a task.

During the software code development process, software developers often make multiple revisions to the software source code. Each time the code is revised and re-compiled, a new version of the data file is created. Large software applications may have thousands of files, each of which may be revised and re-compiled during the development process. Because of the complex interactions of data files within an application, the application must be thoroughly tested to ensure that the intended functionality is working as expected.

Part of the testing process typically includes running the application on a client computer and initializing common tasks within that application. In some cases, running an application on a computer involves converting the application's data files to intermediate code and then to machine code which is directly executable by the processor. Compiled application files are often referred to as binaries. In many cases, an application's data files are set to run in a pre-defined manner where each function receives the same level of priority. In other cases, however, the developer may program the application to give priority to certain functions.

Typically, a developer identifies application functions that are generally more likely to be used based on the developer's knowledge of the application. The developer then configures the application to give those application functions priority during application execution. However, applications are used in diversely configured computer systems for a wide variety of different uses. Thus, a generally more used application function (as determined by the developer) may in fact be less used at a particular computer system. Likewise, a generally less used application function (as determined by the developer) may in fact be more used at a particular computer system. Thus, execution optimizations incorporated by a developer may be underutilized (and potentially not utilized at all) in some computing environments, for example, at particular computer systems that run the application.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments of the present invention are directed to systems, methods, and computer program products for incrementally modifying software programs based on usage data. In one embodiment of this invention, a computer system performs a method for reconfiguring the data object layout within a software application binary. The method involves the computer system instantiating a first instance of a software application binary stored on a storage device. The computer system monitors the first instance of the software application to identify a degree of use of each data object during instantiation of the first instance of the software application.

The computer system stores information that includes the degree of use of data objects monitored during instantiation of the first instance of the software application. The computer system terminates the first instance of the software application. The computer system reconfigures the data object layout within the software application binary as stored on the storage device based on the stored information such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are loaded together.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a computing environment in which embodiments of the present invention may operate including incrementally modifying a software application based on usage data;

FIG. 2 illustrates a flowchart of a method for incrementally modifying a software application based on usage data; and

FIG. 3 illustrates a flowchart of an embodiment of a method for incrementally modifying a software application based on usage data.

### DETAILED DESCRIPTION

Embodiments of the present invention are directed to systems, methods, and computer program products for incrementally modifying software programs based on usage data. In one embodiment of this invention, a computer system performs a method for reconfiguring the data object layout within a software application binary. The method involves the computer system instantiating a software application binary stored on a storage device. The computer system monitors the software application to identify a degree of use of each data object during instantiation of the software application.

The computer system stores information that includes the degree of use of data objects monitored during instantiation of the software application. The computer system terminates the software application. The computer system reconfigures the data object layout within the software application binary as stored on the storage device based on the stored information such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are loaded together.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired and wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

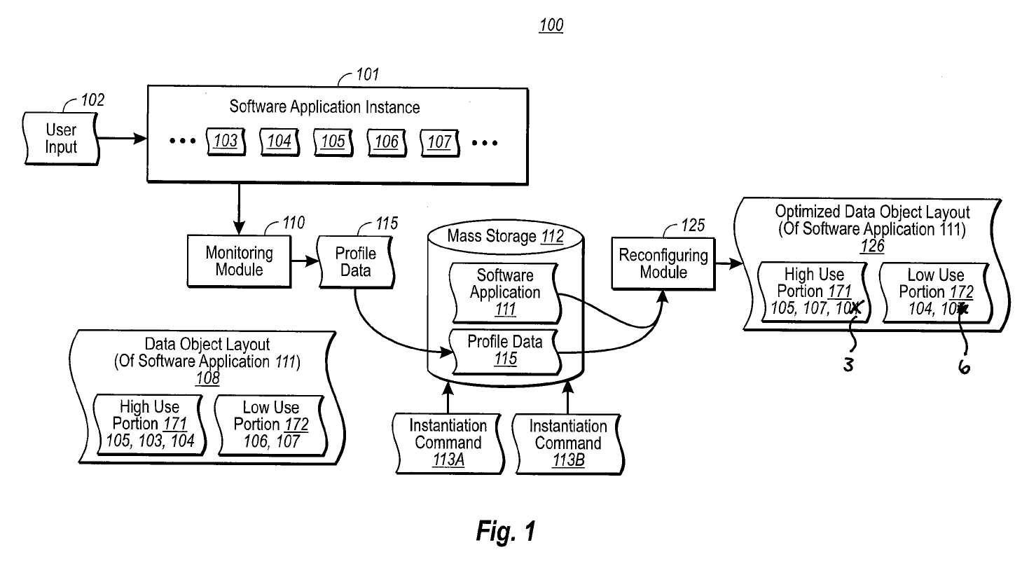

FIG. 1 illustrates an environment 100 (e.g., a computer architecture) in which the principles of the present invention may be employed. The environment 100 includes a monitoring module 110, reconfiguring module 125, and mass storage device 112. Mass storage device 112 can be used to store executable versions of applications (e.g., “.exe” files) and other data, including profile data indicative of the usage of portions of an application during execution. Thus, software application 111 may be an executable version of an application stored at mass storage device 112.

Generally, a software application is a program that allows a user to interface with and perform one or more tasks on a computer system. Once instantiated (e.g., when an application is loaded into system memory and/or executed), software applications perform functions and each function may utilize one or more data objects in the performance of a function.

A data object is an item of information recognizable by a computer system. In some embodiments, data objects may be strings, threads, files (of any type), source code, Common Language Runtime (CLR) code, CLR data structures, or any other computer-readable information. For example, software application 111 includes data objects 103-107 and potentially other data objects represented by the ellipses. However, embodiments with fewer data objects are also possible. Furthermore, data objects (103-107) are data objects of one instantiation of software application 101 and are not shown in any particular order. In any one instantiation, different data objects (apart from those illustrated in environment 100) may be loaded.

In some embodiments, software applications may be instantiated by an instantiation command. For example, software application instance 101 may be an instance of software application 111, instantiated by instantiation command 113A. Similarly, instantiation command 113B may instantiate a new instance of a software application (e.g. software application 111). Instantiation commands 113A & 113B may be automated (i.e. coming from the computer system or from another application) or may come from a computer system user. For example, a computer user may instantiate an application by clicking on a computer icon representing the application. Additionally or alternatively, an application that was previously opened may instantiate other applications to assist in performing tasks.

When a software application is instantiated some data objects of the software application may be essentially immediately loaded into system memory. Other data objects of the software application are loaded on demand (or dynamically) when software application functionality so indicates. For example, upon instantiation a particular application, data objects for printing may not be loaded into memory by default. However, in response to receiving subsequent user-input indicative of a user attempting to print, the data objects for printing can then be loaded.

As depicted, software application 111 is structured on mass storage 112 in accordance with data object layout 108. After the data objects for a software application are written in source code, the data objects may be compiled into an application binary. In some embodiments, software applications may include a data object placement scheme where data objects that are accessed together temporally for more important usage scenarios are also grouped together spatially in the application binary. Thus, in some embodiments, an application binary may include a high-use portion and a low-use portion. For example, data object layout 108 includes high-use portion 171 and low-use portion 172. Data objects may be placed in either the high-use or low-use portion of the application binary. For example, data objects that were highly used during training scenarios (e.g., during development) for software application 111 (e.g., 105, 103, and 104) can be grouped high-use portion 171. On the other hand, data objects that were rarely used during training scenarios for software application 111 may be grouped in low-use portion 172.

A data object placement scheme may be advantageous in normal software application use because typically some functions or data objects of a software application will be used more than others. The placement scheme may be based on what the software application developer perceived at the time of development to be the most and the least used functions. Additionally or alternatively, a data object placement scheme may be based on prior tests or prior instantiations of the software application. Some application binaries may have no data object placement scheme, while others may have a more complex scheme than the above example with two portions (high-use and low-use), as will be explained further below.

Data object layout 108 represents grouped portions of software application 111 as stored on mass storage 112, where high-use data objects (e.g. 105) are grouped with other high-use data objects in high-use portion 171 and low-use data objects (e.g. 107) are grouped with other low-use data objects in low-use portion 172. (Although some overlap of high-use objects into low-use portion 172 and of low-use objects into high-use portion 171 can occur). Thus, data objects perceived or previously determined during development to be higher user data objects can be grouped together and stored across fewer pages on disk.

During execution of an application, computer system memory can be conserved because previously grouped data objects in high-use portion 171 are more likely to be loaded together. For example, when a function is called (causing high-use data objects corresponding to the function to be dynamically loaded), the number of disk pages that is loaded into memory in order to access the high-use data objects for that function can be reduced, thereby conserving system memory. The data objects grouped in the low-use portion 172 may remain unloaded until a rarely-used function is called.

Thus, the potential to load data objects from fewer number of disk pages, wherein each disk page includes a relatively high number of high-use data objects is (potentially significantly) increased. On the other hand, the potential for loading data objects from a relatively large number of pages, wherein each disk page includes a relatively low number of high-use data objects (and possibly a relatively large number of low-use data objects) can be reduced (and potentially eliminated).

In other embodiments, data object layout 108 can include three or more levels of data object placement. For example, data object layout 108 may include three levels of data object placement where data objects may be assigned one of the three levels of priority (e.g. high, medium, and low).

As previously described, environment 100 also includes a monitoring module 110. After software application 101 is instantiated, software application 101 can receive user input 102 from a user in environment 100. Monitoring module 110 can monitor and evaluate user input 102 as the functionality of application is utilized. The monitoring module 110 may be capable of observing the use of a software application instance 101 and detecting the degree of use of data objects (103-107) within the software application instance 101. For example, while using a software application instance 101, a software application user may enter input that causes different functions within software application 101 to be called.

The monitoring module 110 monitors the use of each data object (103-107), such as, for example, each function call, each opening of a data object, each time a data object is accessed, transferred, copied or otherwise used in any way. Based on the monitoring of an evaluation, monitoring module 100 can create profile data 115. Profile data 115 may include information regarding how the data object was used, when it was used, what function called it, how long it was used, or any other determination of use. When software application instance 101 is terminated (e.g., in response to a “close” command) profile data 115 can be stored at mass storage device 112 for use by other modules in environment 100.

As previously described, environment 100 also includes a reconfiguring module 125. In some embodiments, reconfiguring module 125 is capable of reconfiguring the data object layout 108. The reconfiguring module 125 may reconfigure the data object layout 108 in any order with the outcome being an optimized data object layout 126. In some embodiments, the data objects may be listed in the order they will be placed in the binary (even if loaded dynamically in a different order at runtime). In some embodiments, instantiation command 113B may cause reconfiguration module 125 to reconfigure the application data objects into optimized data object layout 126.

Optimized data object layout 126 may be the same as the original data object layout 108, or, optimized data object layout 126 may be entirely different. In some embodiments, after terminating software application instance 101, reconfiguring module 125 may reconfigure the location of data objects in high-use portion 171 and low-use portion 172. Reconfiguring module 125 can reconfigure based on profile data 115 received from the monitoring module 10 and the current data object layout software application 111 (e.g., data object layout 108). In this manner, the reconfiguring module 125 may reconfigure the data objects (103-107) to generate a new, data object layout 126 that will load data objects in a fashion related to the degree of use as measured by the monitoring module 10 combined with the current data object layout. In some embodiments, after reconfiguration, optimized data object layout 126 is used to determine data objects that are loaded together in subsequent instantiations of software application 111.

For example, if a data object was used more than once by a computer system user, the reconfiguring module 125 may reconfigure the data object's location within optimized data object layout 126, grouping the high-use data objects together within data object layout 126. Similarly, if a data object was not used at all by the user, the reconfiguring module 125 may reconfigure the data object's location within optimized data object layout 126, grouping the low-use data objects together within data object layout 126. If usage is appropriately reflected in an existing data object layout, reconfiguring module 125 may refrain from modifying the data object layout.

Additionally or alternatively, a use threshold may be used to determine whether a data object layout 108 is to be reconfigured or not. For example, if an arbitrary threshold of two uses was set and a data object was used twice or more by the user, that data object may be reconfigured and placed in a high-use portion of the application binary because the data object met the threshold degree of use. In the same example, if the data object had been used only once or no times by the user, that data object would be reconfigured and placed in a low-use portion of the application binary because the data object failed to meet the threshold degree of use. Note that when referring to a use threshold, the use may be any of the aforementioned uses including, but not limited to, each function call, each opening of a data object, each time a data object is accessed, transferred, copied or otherwise used in any way. The threshold may vary according to the particular use monitored by the monitoring module 110.

Software application 101 may be instantiated multiple times and, as a result, the data object layout may be modified multiple times. For example, data object layout 108 can be modified into data object layout 126, and subsequently data object layout 126 can be modified based on further detected usage of data objects in software application 111. The subsequent use of data objects (103-107) can be monitored by the monitoring module 110, which may maintain profile data 115 about which data objects within the new instance of software application 111 (having data objects loaded in accordance with optimized data object layout 126) were used by the user.

Thus, through each use of the application, the profile data 115 may change, depending on data object use as monitored by the monitoring module 110. As the profile data 115 changes, the reconfiguring module 125 can reconfigure the data object layout of software application 111 (i.e., changing how data objects are grouped on disk). In this manner, data objects that were used by the user in a software application may be grouped in a high-use portion of the application binary and data objects that were not used by the user may be grouped in a low-use portion of the application binary. This may lead to quicker data object load times and decreased memory usage, specifically optimized for the application user.

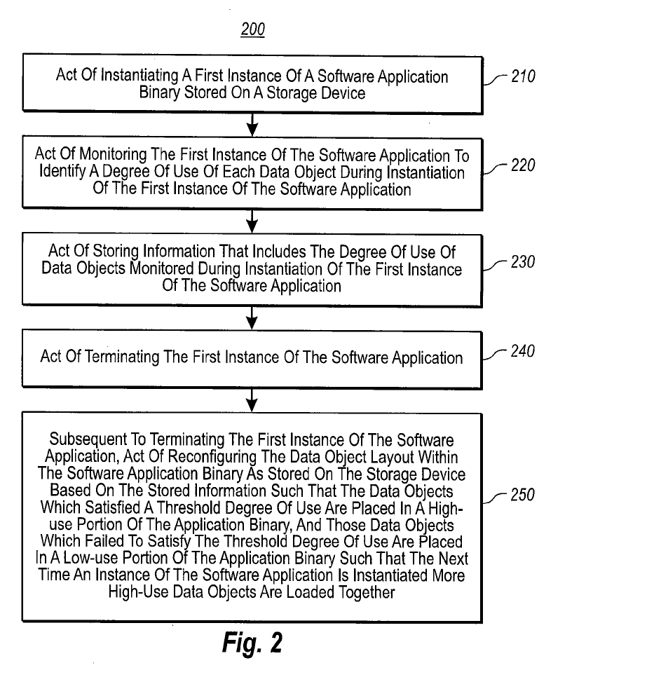

FIG. 2 illustrates a flowchart of a method 200 for modifying software programs based on usage data. The method 200 will now be described with frequent reference to the components and data of environment 100.

Method 200 includes an act of instantiating a first instance of a software application binary stored on a storage device (act 210). For example, software application instance 101 (e.g. an instance of software application 111) may be instantiated and may receive user input 102. The application instance may have, for example, multiple data objects (103-107). In some embodiments, data objects may have a data object layout 108 that determines which data objects (103-107) will be loaded together. For example, those more data objects grouped in the high-use portion 171 can be loaded together.

As previously described, a software application can be configured to load data objects together according to a pre-defined data object placement, for example, defined by the software application developer. For instance, the software application developer may have placed functions and/or data objects that the he or she determined would be used most often in the high-use portion of the application binary. Moreover, the developer may have conducted test scenarios to determine which application data objects were used most often and ultimately based the data object placement (at least partially) on the results of those tests.

Method 200 also includes an act of monitoring the first instance of the software application to identify a degree of use of each data object during instantiation of the first instance of the software application (act 220). For example, a monitoring module 110 may monitor software application instance 101 to identify a degree of use of each data object (103-107) during instantiation of the software application. This may be advantageous in cases where some users use certain functions repeatedly and seldom, if ever, use other functions. Those functions or data objects which are seldom used may be placed in the low-use portion of the data object layout 108. In this manner, the software application 101 may be optimized for each individual user.

Method 200 includes an act of storing information that includes the degree of use of data objects monitored during instantiation of the first instance of the software application (act 230). For example, mass storage device 112 may store information that includes the degree of use of data objects monitored during instantiation of the software application 111. The stored information may be profile data 115. The profile data 115 may include usage data such as block weights. Block weights indicate the number of times a block of code was executed during the instantiation of the application. Profile data 115 may, additionally or alternatively, include usage patterns indicating how data objects were used within the application during the instantiation of the application. Usage patterns may include, for each data object, how the data object was used, which function used the data object, how long the data object was in use, the data and time of the last usage, or any other measurement of use.

Method 200 also includes an act of terminating the first instance of the software application (act 240). For example, the computer system may terminate software application instance 101. Software application instance 101 may also be terminated by a computer system user. For example, the user may enter a “close” command to close the software application (e.g. software application 111)

Method 200 also includes, subsequent to terminating the first instance of the software application, an act of reconfiguring the data object layout within the software application binary as stored on the storage device based on the stored information such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are loaded together (act 250).

For example, subsequent to terminating software application instance 101, reconfiguring module 125 may reconfigure data object layout 108 based on profile data 115 such that the data objects (103-107) which satisfied a threshold degree of use are placed in a high-use portion 171, and those data objects which failed to satisfy the threshold degree of use are placed in a low-use portion 172 such that the next time an instance of software application 111 is instantiated, more high-use data objects are loaded together.

It may be advantageous to alter the data object layout 108. For example, if a user never, or at least very rarely, prints documents, the user's printing function may be reconfigured such that the printing function data objects are placed in a low-use portion of the user's application binary. As stated above, the data object layout 108 may be reconfigured into optimized data object layout 126 In this example, the printing function data objects may be grouped in the low-use portion of binary arrangement 152.

In another example, it may be advantageous to set a threshold degree of use where, if the threshold degree of use is satisfied, that data object may be placed in a high-use portion of the application binary. For instance, if a user set a use threshold of two uses for printing data objects and the user caused the data objects to be utilized once (e.g., using printing function just one time), the threshold degree of use would not be satisfied. Thus, the printing data objects would be placed in a low-use portion of the application binary. However, if user caused the printing data objects two or more times (e.g., using printing function two or more times), the threshold degree of use would be satisfied and the printing data objects would be grouped in a high-use portion of the application binary (and thus could be loaded from few number of disks pages in the future)).

In some embodiments, Method 200 may be repeated each time an application is used. In this manner, the user's actions are monitored (specifically, the use of data objects within applications is monitored) and the application may be incrementally modified and optimized to load data objects which are used most often together. This is accomplished by grouping those high-use data objects together in a high-use portion of the application binary.

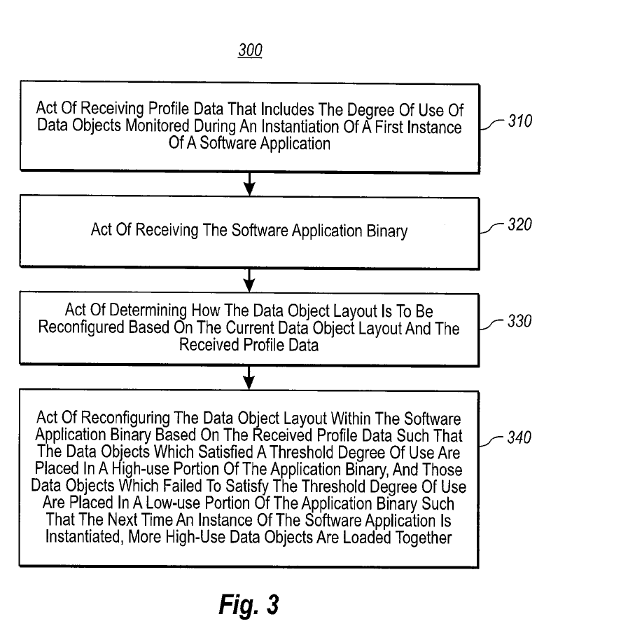

FIG. 3 illustrates a flowchart of a method 300 for modifying software programs based on usage data. The method 300 will now be described with frequent reference to the components and data of environment 100.

Method 300 includes an act of receiving profile data that includes the degree of use of data objects monitored during an instantiation of a first instance of a software application (act 310). For example, reconfiguration module 125 may receive profile data 115 that includes the degree of use of data objects monitored during instantiation of software application instance 101. Profile data 115 may be stored in mass storage device 112 and may include, for example, usage data such as block weights. Block weights indicate the number of times a block of code was executed during the instantiation of the application. Profile data 115 may, additionally or alternatively, include usage patterns indicating how data objects were used within the application during the instantiation of the application. Usage patterns may include, for each data object, how the data object was used, which function used the data object, how long the data object was in use, the data and time of the last usage, or any other measurement of use.

Method 300 also includes an act of receiving the software application binary (act 320). For example, reconfiguration module 125 may receive the binary for software application 111. The binary may be an image of all data objects within application 111.

Method 300 also includes an act of determining how the data object layout is to be reconfigured based on the current data object layout and the received profile data (act 330). For example, the reconfiguration module 125 may determine how data object layout 108 is to be reconfigured based on the current data object layout of software application 111 and profile data 115. In some embodiments, reconfiguration module 125 may compare the usage information within profile data 115 to the current data object layout of software application 111 (e.g. data object layout 108). Depending on usage thresholds, as explained below, data object layout 108 may be reconfigured and replaced by optimized data object layout 126.

Method 300 also includes an act of reconfiguring the data object layout based on the received profile data such that the data objects which satisfied a threshold degree of use are grouped together in a high-use portion of the application binary, and those data objects which failed to satisfy the threshold degree of use are grouped together in a low-use portion of the application binary such that the next time an instance of the software application is instantiated more high-use data objects are loaded together.

For example, reconfiguring module 125 may reconfigure the data object layout 108 based on received profile data 115 such that the data objects (103-107) which satisfied a threshold degree of use are placed in a high-use portion of the application binary, and those data objects which failed to satisfy the threshold degree of use are placed in a low-use portion of the application binary such that the next time an instance of software application 111 is instantiated more high-use data objects are loaded together

As previously described embodiments of the invention facilitate determining which particular data objects are being accessed during the most important end-user scenarios, and making sure that those are grouped together in the binary on the same pages on disk. The grouped objects can then be loaded together so that a reduced number of pages need to be fetched from the hard-disk to run these important scenarios. In some embodiments, the computer system monitors how specific end-user scenarios grow more or less important with the passage of time. Thus, as certain end-user scenarios become less important, the corresponding data objects in the binary can be appropriately moved between high-use and low-use portions of the application binary.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system configured to process application commands, a method for reconfiguring the data object layout within a software application binary, the method comprising the acts of:
instantiating a first instance of a software application binary stored on a storage device;
monitoring the first instance of the software application to identify a degree of use of each data object during instantiation of the first instance of the software application;
storing information that includes the degree of use of data objects monitored during instantiation of the first instance of the software application;
terminating the first instance of the software application; and
subsequent to terminating the first instance of the software application, reconfiguring the data object layout within the software application binary as stored on the storage device based on the stored information such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are as loaded together.

2. The method of claim 1, wherein the method of claim 1 is repeated each time the application is used.

3. The method of claim 1, wherein the data object layout comprises a list of computer-readable instructions indicating which data objects in the application binary are to be processed upon instantiation of the application.

4. The method of claim 1, wherein the data objects that are accessed together temporally are placed together spatially in the binary.

5. The method of claim 1, wherein the stored information comprises profile data.

6. The method of claim 5, wherein the profile data comprises block weights indicating the number of times a block of code was executed during the instantiation of the application.

7. The method of claim 5, wherein the profile data comprises usage patterns indicating how data objects were used within the application during the instantiation of the application.

8. A computer program product for use at a computer system, the computer program product for implementing a method for reconfiguring the data object layout within a software application binary, the computer program product comprising one or more computer-readable storage media having stored thereon computer-executable instructions that, when executed by one or more processors of the computer system, cause the computer system to perform the following:
instantiate a first instance of a software application binary stored on a storage device;
monitor the first instance of the software application to identify a degree of use of each data object during instantiation of the first instance of the software application;
store information that includes the degree of use of data objects monitored during instantiation of the first instance of the software application;
terminate the first instance of the software application; and
subsequent to terminating the first instance of the software application, reconfigure the data object layout within the software application binary as stored on the storage device based on the stored information such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are loaded together.

9. The computer program product of claim 8, wherein the data object layout comprises a list of computer-readable instructions indicating which data objects in the application binary are to be processed upon instantiation of the application.

10. The method of claim 1, wherein the stored information comprises profile data.

11. The method of claim 10, wherein the profile data comprises block weights indicating the number of times a block of code was executed during the instantiation of the application.

12. The method of claim 10, wherein the profile data comprises usage patterns indicating how data objects were used within the application during the instantiation of the application

13. At a computer system configured to process data objects, a method for incrementally reconfiguring data object layout within a software application binary, the method comprising the acts of:
receiving profile data that includes the degree of use of data objects monitored during an instantiation of a first instance of a software application;
receiving the software application binary;
determining how the data object layout is to be reconfigured based on the current data object layout and the received profile data; and
reconfiguring the data object layout within the software application binary based on the received profile data such that the data objects which satisfied a threshold degree of use are placed in a high-use portion of the application binary, and those data objects which failed to satisfy the threshold degree of use are placed in a low-use portion of the application binary such that the next time an instance of the software application is instantiated more high-use data objects are loaded together.

14. The method of claim 13, wherein prior use of the application comprises development of the application.

15. The method of claim 13, wherein prior use of the application comprises prior instantiation of the application.

16. The method of claim 13, wherein at least one pre-determined highly-used data object is placed in a low-use portion of the application binary due to failing to satisfy the threshold degree of use.

17. The method of claim 13, wherein at least one pre-determined highly-used data object is placed in a high-use portion of the application binary due to satisfying the threshold degree of use.

18. The method of claim 13, wherein data objects that are accessed together temporally are placed together spatially in the software application binary.

19. The method of claim 13, wherein the profile data comprises block weights indicating the number of times a block of code was executed during the instantiation of the application.

20. The method of claim 13, wherein the profile data comprises usage patterns indicating how data objects were used within the application during the instantiation of the application
